(19) United States
(12) Patent Application Publication
(10) Pub. No.: US 2025/0282984 A1
(43) Pub. Date: Sep. 11, 2025

(54) Radiation-Curable Adhesive Composition

(71) Applicant: Henkel AG & Co. KGaA, Duesseldorf (DE)

(72) Inventors: Bin Zhao, Shanghai (CN); Sophia TengFang Wang, Shanghai (CN); Bruce BaoShan Gao, Shanghai (CN); Stanley XiaoLong Hu, Shanghai - WaiGaoQiao (CN); ShanXiang Cai, Shanghai - WaiGaoQiao (CN)

(21) Appl. No.: 19/218,778

(22) Filed: May 27, 2025

Related U.S. Application Data
(63) Continuation of application No. PCT/CN2022/137600, filed on Dec. 8, 2022.

(51) Int. Cl. C09J 163/00; B32B 7/12; C08G 59/24; C08G 59/68; C09J 4/06; C09J 5/00

(52) U.S. Cl. CPC C09J 163/00; B32B 7/12; C08G 59/24; C08G 59/68; C09J 4/06; C09J 5/00; C09J 2203/326

(57) ABSTRACT

The present invention provides a radiation-curable adhesive composition comprising (A) at least one cationically polymerizable component, (B) at least one photoinitiator system comprising (B1) at least one ferrocenium salt, and (B2) at least one aromatic iodonium salt, (C) at least one peroxide, and (D) optionally at least one free radically polymerizable compound; wherein the mass ratio between the component (B2) to the component (B1) is from 0.25 to less than 4; and the mass ratio between the component (C) to the component (B1) is from 0.5 to 8.

### TECHNICAL FIELD

The present invention relates to a radiation-curable adhesive composition, particularly relates to a radiation-curable adhesive composition capable of being cured by radiation penetrating a polymer film, and exhibiting excellent adhesion strength when cured and use thereof.

### BACKGROUND OF THE INVENTION

Radiation-curable adhesive compositions have been widely used in the semiconductor and electronics field, because of high curing efficiency, excellent storage stability, energy-saving and applicable for heat sensitive electronic components or modules. LEDs are semiconductor devices which utilize the phenomenon of electroluminescence to generate light for curing radiation-curable adhesive compositions. At present, LED light sources currently emit light at wavelengths between 300 and 475 nm, with 365 nm, 390 nm, 395 nm, 405 nm, 415 nm and 450 nm being common peak spectral outputs.

Progress in electronic technology is continuously occurring throughout the world by striving to develop lighter, thinner and more flexible electronic devices. As a result, polymer film materials e.g., polyimide (PI) films have been played an important role in electronics due to their excellent properties such as good heat stability, excellent chemical resistance and dielectric property. However, such polymer films block light to a great extent. For instance, the maximum transmittance of PI film is only 0.08% for light wavelength less than 400 nm. Therefore, to activate the curing for radiation-curable adhesive compositions beneath polymer films, radiation with wavelength of no less than 400 nm should be performed. However, diaromatic iodonium salts served as cationic photoinitiator in radiation-curable adhesive compositions can only be activated by radiation of wavelength of less than 365 nm unless suitable sensitizer selected from anthracene, perylene, phenothiazine, xanthone, thioxanthone, benzophenone, ethyl-4 dimethylaminobenzoate or sterically hindered amines is added. By doing so, such sensitizers would greatly affect the strength of the radiation-curable adhesive compositions which cured.

US 2022/0064367 A1 disclosed radiation-curable adhesive compositions with at least one cationically polymerizable component, a first photoinitiator releasing an acid when irradiated with actinic radiation of a first wavelength λ₁, and a second photoinitiator releasing an acid when irradiated with actinic radiation of a second wavelength λ₂, wherein the second wavelength λ₂ is shorter than the first wavelength λ₁, and wherein the second photoinitiator, after irradiation of the composition with actinic radiation of the first wavelength λ₁, shows an absorption of actinic radiation of the second wavelength λ₂ in the composition that is sufficient to activate the second photoinitiator and fix the composition. The composition can be activated with a sequential light radiation at different wavelengths. However, this process needs two light sources and has two curing steps to reach fully cure.

CN 105273167A disclosed the use of ferrocenium salts as sensitizers for the photopolymerization of cationically curable compositions with photoinitiators based on iodonium salts. The ferrocenium salts are used stoichiometrically and allow the initiation of the polymerization by the iodonium initiator under visible light radiation.

All the prior art above does not suggest how to solve incomplete cure issue due to light loss where the composition beneath a polymer film and how to produce cured product with high adhesion strength simultaneously. To obtain fully cure of the radiation-curable compositions, thermal cure and moisture are current approaches. However, thermal cure approach requires high temperature (no less than 60° C.), which is not applicable for temperature sensitive devices. While moisture cure approach normally takes 3 to 7 days to reach full cure, which is time-consuming.

In view of the above, there is still a need for a radiation-curable adhesive composition capable of being cured by radiation penetrating a polymer film and exhibiting excellent adhesion strength when cured.

### SUMMARY OF THE INVENTION

According to a first aspect of the invention, disclosed herein is a radiation-curable adhesive composition comprising
(A) at least one cationically polymerizable compound,
(B) at least one photoinitiator system comprising
   (B1) at least one ferrocenium salt, and
   (B2) at least one aromatic iodonium salt,
(C) at least one peroxide, and
(D) optionally at least one free radically polymerizable compound;
   wherein the mass ratio between the component (B2) to the component (B1) is from 0.25 to less than 4; and the mass ratio between the component (C) to the component (B1) is from 0.5 to 8.

According to a second aspect of the invention, provided herein is a connection structure, comprising a first part, a second part, and an adhesive sandwiched therebetween, wherein the first and second parts are independently of each other selected from a glass, a resin and a metal, and the adhesive being formed by curing the radiation-curable adhesive composition of the present invention.

According to a third aspect of the invention, provided herein is the method of preparing a connection structure according to the present invention comprising the following steps:
(a) providing a radiation-curable composition according to the present invention,
(b) applying the composition onto a first part,
(c) applying a second part to the composition on the first part thus forming a connection structure,
(d) irradiating the connection structure with visible light having a wavelength of no less than 400 nm, preferably from 400 nm to 500 nm, and
(e) optionally heating the composition on the connection structure.

According to a fourth aspect of the invention, provided herein is an electronic device, comprising the connection structure of the present invention or produced using the radiation-curable adhesive composition according to the present invention.

According to a fifth aspect of the invention, provided herein is the use of the radiation-curable adhesive composition according to the present invention or the connection structure according to the present invention in manufacturing electronic devices.

Other features and aspects of the subject matter are set forth in greater detail below.

### DETAILED DESCRIPTION OF THE INVENTION

It is to be understood by one of ordinary skill in the art that the present invention is a description of exemplary embodiments only and is not intended as limiting the broader aspects of the present invention. Each aspect so described may be combined with any other aspect or aspects unless clearly indicated to the contrary. In particular, any feature indicated as being preferred or advantageous may be combined with any other feature or features indicated as being preferred or advantageous.

Unless specified otherwise, in the context of the present invention, the terms used are to be construed in accordance with the following definitions.

Unless specified otherwise, as used herein, the terms “a”, “an” and “the” include both singular and plural referents.

The terms “comprising” and “comprises” as used herein are synonymous with “including”, “includes” or “containing”, “contains”, and are inclusive or open-ended and do not exclude additional, non-recited members, elements or process steps.

The term “at least one” or “one or more” used herein to define a component refers to the type of the component, and not to the absolute number of molecules. For example, “one or more polyols” means one type of polyol or a mixture of a plurality of different polyols.

The term “visible light” used herein means light has wavelength of no less than 400 nm, preferably from 400 nm to 500 nm.

The term “crosslinking” or “curing” used herein means polymerization or addition reaction beyond the gel point. The gel point is the point at which the storage modulus G′ becomes equal to the loss modulus G″.

The term “room temperature” as used herein refers to a temperature of about 20° C. to about 25° C., preferably about 25° C.

Unless specified otherwise, the recitation of numerical end points includes all numbers and fractions subsumed within the respective ranges, as well as the recited end points.

All references cited in the present specification are hereby incorporated by reference in their entirety.

The molecular weights refer to number average molecular weights (Mn), unless otherwise stipulated. All molecular weight data refer to values obtained by gel permeation chromatography (GPC), unless otherwise stipulated, e.g., according to DIN 55672.

Unless otherwise defined, all terms used in the present invention, including technical and scientific terms, have the meaning as commonly understood by one of the ordinary skilled in the art to which this invention belongs.

In one aspect, the present disclosure is generally directed to a radiation-curable adhesive composition comprising
(A) at least one cationically polymerizable component,
(B) at least one photoinitiator system comprising
   (B1) at least one ferrocenium salt, and
   (B2) at least one aromatic iodonium salt,
(C) at least one peroxide, and
(D) optionally at least one free radically polymerizable compound;
   wherein the mass ratio between the component (B2) to the component (B1) is from 0.25 to less than 4; and the mass ratio between the component (C) to the component (B1) is from 0.5 to 8.

### (A) Cationically Polymerizable Component

According to the present invention, the radiation-curable adhesive composition comprises at least one cationically polymerizable component (A).

In some embodiments, the component (A) can be epoxy-containing compound. Epoxy-containing compounds are cationically curable, by which is meant that polymerization and/or crosslinking and other reactions of the epoxy group can be initiated by cations. These compounds may be monomers, oligomers or polymers and are sometimes referred to as “resins.” Such compounds may have an aliphatic, aromatic, cycloaliphatic or heterocyclic structure; they can comprise epoxide groups as side groups or groups that form part of an alicyclic or heterocyclic ring system.

Examples of suitable epoxy-containing compounds include polyglycidyl and poly(methylglycidyl) esters of polycarboxylic acids, or poly(oxiranyl) ethers of polyethers. The said polycarboxylic acid can be aliphatic, such as, for example, glutaric acid, adipic acid and the like; cycloaliphatic, such as, for example, tetrahydrophthalic acid; or aromatic, such as, for example, phthalic acid, isophthalic acid, trimellitic acid, or pyromellitic acid. The said polyether can be poly(tetramethylene oxide).

Suitable epoxy-containing compounds also include polyglycidyl or poly(-methylglycidyl) ethers obtainable by the reaction of a compound having at least one free alcoholic hydroxy group and/or phenolic hydroxy group and a suitably substituted epichlorohydrin. The alcohols can be acyclic alcohols, such as, for example, ethylene glycol, diethylene glycol, and higher poly(oxyethylene) glycols; cycloaliphatic, such as, for example, 1,3- or 1,4-dihydroxycyclohexane, bis(4-hydroxycyclohexyl) methane, 2,2-bis(4-hydroxycyclohexyl)propane, or 1,1-bis(hydroxymethyl)cyclohex-3-ene; or contain aromatic nuclei, such as N,N-bis(2-hydroxyethyl) aniline or p,p′-bis(2-hydroxyethylamino)diphenylmethane.

Other suitable epoxy-containing compounds include those which may be derived from mono nuclear phenols, such as, for example, resorcinol or hydroquinone, or they may be based on polynuclear phenols, such as, for example, bis(4-hydroxyphenyl) methane (bisphenol F), 2,2-bis(4-hydroxyphenyl)propane (bisphenol A), or on condensation products, obtained under acidic conditions, of phenols or cresols with formaldehyde, such as phenol novolacs and cresol novolacs.

Suitable epoxy-containing compounds also include poly(N-glycidyl) compounds, which are, for example, obtainable by dehydrochlorination of the reaction products of epichlorohydrin with amines that comprise at least two amine hydrogen atoms, such as, for example, n-butylamine, aniline, toluidine, m-xylylene diamine, bis(4-aminophenyl) methane or bis(4-methylaminophenyl) methane. Suitable poly(N-glycidyl) compounds also include N,N′-diglycidyl derivatives of cycloalkyleneureas, such as ethyleneurea or 1,3-propyleneurea, and N,N′-diglycidyl derivatives of hydantoins, such as of 5,5-dimethylhydantoin.

Examples of suitable epoxy-containing compounds include poly(S-glycidyl) compounds which are di-S-glycidyl derivatives which are derived from dithiols, such as, for example, ethane-1,2-dithiol or bis(4-mercaptomethylphenyl) ether.

It is, however, also possible to use epoxy resins in which the 1,2-epoxy groups are bonded to different heteroatoms or functional groups. Those compounds include, for example, the N,N,O-triglycidyl derivative of 4-aminophenol, the glycidyl ether glycidyl ester of salicylic acid, N-glycidyl-N′-(2-glycidyloxypropyl)-5,5-dimethylhydantoin, or 2-glycidyloxy-1,3-bis(5,5-dimethyl-1-glycidylhydantoin-3-yl)propane.

Preferable epoxy-containing compounds are cycloaliphatic epoxy resins selected from 3-cyclohexenylmethyl-3-cyclohexylcarboxylate diepoxide, 3,4-epoxycyclohexylmethyl-3,4-epoxycyclohexanecarboxylate, 3,4-epoxy-6-methyl-cyclohexylmethyl-3,4-epoxy-6-methylcyclohexanecarboxylate, 2,2-bis(4-hydroxycyclohexyl)propane diglycidyl ether, di(3,4-epoxycyclohexylmethyl)hexanedioate, di(3,4-epoxy-6-methylcyclohexylmethyl)hexanedioate, ethylenebis(3,4-epoxycyclohexanecarboxylate), ethanedioldi(3,4-epoxycyclohexylmethyl) ether, 2-(3,4-epoxycyclohexyl-5,5-spiro-3,4-epoxy)cyclohexane-1,3-dioxane, and combinations thereof.

Typical examples of cycloaliphatic epoxy resins include those represented by formulae (I) to (V):

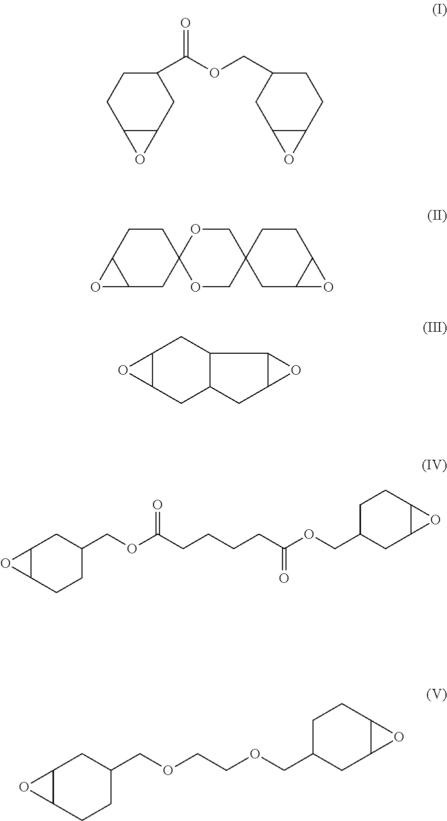 [SMILES: O=C(OCC1CCC2OC2C1)C1CCC2OC2C1 ; C1CC2(COC3(CCC4OC4C3)OC2)CC2OC12 ; C1C2CC3OC3C2CC2OC12 ; O=C(CCCCC(=O)OCC1CCC2OC2C1)OCC1CCC2OC2C1 ; C(COCC1CCC2OC2C1)OCC1CCC2OC2C1]

It is preferred that the epoxy compounds comprise at least one cyclohexeneoxide structure, more preferably at least 2 cyclohexeneoxide structures.

The epoxy-containing compounds can have molecular weights which vary over a wide range. In general, the epoxy equivalent weight, i.e., the number average molecular weight divided by the number of reactive epoxy groups, is preferably in the range of 60 to 1000.

Suitable commercially available epoxy-containing compounds used as component (A) are products available under the trade names CELLOXIDE™ 2021P, CELLOXIDE™ 8000 by Daicel Corporation; EPIKOTE™ RESIN 828 LVEL, EPIKOTE™ RESIN 166, EPIKOTE™ RESIN 169 by Momentive Specialty Chemicals B. V., Netherlands, Epilox™ resins from the product series A, T and AF by Leuna Harze, Germany, or EPICLON™ 840, 840-S, 850, 850-S, EXA8SOCRP, 850-LC by DIC K. K., Japan, Omnilane 1005 and Omnilane 2005 by 1GM Resins B.V., Syna Epoxy 21 and Syna Epoxy 06 by Synasia Inc., TTA2 1, TTA26, TTA6O and TTA128 by Jiangsu Tetra New Material Technology Co. Ltd.

Other cationically polymerizable components that may be used in the composition of the present invention include, for instance, cyclic ether compounds, cyclic lactone compounds, cyclic acetal compounds, cyclic thioether compounds, spiro-orthoester compounds, and oxetane compounds.

It is of course possible to use mixtures of cationically polymerizable components in the compositions according to the invention.

With particular preference, the component (A) may be present in an amount of from 2% to 99% by weight, and preferably from 5% to 95% by weight, based on the total weight of the adhesive composition.

### (B) Photoinitiators

According to the present invention, the radiation-curable adhesive composition comprises at least one photoinitiator system comprising (B1) at least one ferrocenium salt; and (B2) at least one aromatic iodonium salt; wherein the mass ratio between component (B2) to component (B1) is from 0.25 to less than 4. The photoinitiator system is able to produce cationic active species by visible light under existence of component (C) peroxide described herein.

Examples of suitable ferrocenium salts (B1) are selected from cumenylcyclopentadienyl iron (II) hexafluorophosphate, cumenylcyclopentadienyl iron (II) hexafluoroantimonate, naphthalenylcyclopentadienyl iron (II) hexafluorophosphate, benzylcyclopentadienyl iron (II) hexafluorophosphate and cyclopentadienyl carbazole iron (II) hexafluorophosphate, and combinations thereof.

The aromatic iodonium salt (B2) used in the present invention can be represented by A⁺B⁻, wherein the A⁺ is an aromatic iodonium ion and can be represented by the formula:

Ar¹—I⁺—Ar²,

In which groups Ar¹ and Ar² attached to I⁺ are, independently each represent an aromatic group, preferably phenyl groups, optionally having substituent group; and the anion B can be selected from HSO₄⁻, PF₆⁻, SbF₆⁻, AsF₆⁻, Cl⁻, Br⁻, ClO₄⁻, PO₄⁻, SO₃CF₃⁻, aluminates or a borate anion, preferably BF₄⁻, B(C₆F₅)₄⁻, B(C₆F₄OCF₃)₄⁻, B(C₆F₄CF₃)₄⁻ and combinations thereof.

In preferred embodiments, the component (B2) can be diaryliodonium salts represented by the following formulae (VI) to (XI):

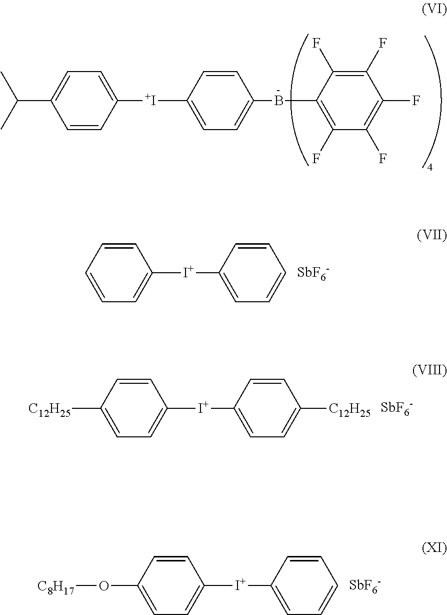

Examples of suitable iodonium salts (B2) can be selected from [4-(isooctyloxy)phenyl]2-pyrazoyliodonium hexafluoroantimonate; [4-(2-ethylhexyloxy)phenyl]phenyliodonium hexafluoroantimonate; [4-(2-methylpentoxy)phenyl]phenyliodonium tetrafluoroborate; [4-(3-methylpentoxy)phenyl]phenyliodonium hexafluorophosphate; [4-(4-methylpentoxy)phenyl]phenyliodonium hexafluoroantimonate; [4-(2-propylpentoxy)phenyl]phenyliodonium hexafluoroantimonate; [4-(2,4,4-trimethylpentoxy)phenyl]phenyliodonium hexafluorophosphate; [4-(2-ethylheptyloxy)phenyl]phenyliodonium hexafluoroarsenate; [4-(3,7-dimethyloctyloxy)phenyl]phenyliodonium hexafluoroantimonate; [4-(2-ethylhexyloxy)phenyl]-2-thienyliodonium hexafluorophosphate, [4-(2-ethylhexyloxy)phenyl]2-furanyl-iodonium hexafluoroantimonate, tolylcumyliodonium-tetrakis pentafluorophenylborate, and combinations thereof. More examples are disclosed in, for example, U.S. Pat. Nos. 3,565,906; 3,712,920; 3,759,989, and 3,763,187.

According to the present invention, a combination of at least one ferrocenium salt (B1) and at least one aromatic iodonium salt (B2) is served as the photoinitiators in the radiation-curable adhesive composition, wherein the mass ratio between component (B2) to component (B1) is from 0.25 to less than 4, preferably from 0.25 to 3, more preferably from 0.25 to 2, even more preferably from 0.5 to 1.8. If the mass ratio between component (B2) to component (B1) is lower than 0.25 or larger than 4 (equal to 4), the adhesion strength of the radiation-curable adhesive composition when cured is not sufficient for application.

In preferred embodiments, the component (B) does not comprise any aryl sulfonium salts.

Suitable commercially available components (B1) are sold under R-Gen™ 261 and R-Gen™ 262 from Chitec Technology.

Suitable commercially available components (B2) are sold under UV1242 and UV2257 by Deuteron, and BLUESIL™ PI 2074 by Bluestar.

With particular preference, the component (B1) may be present in an amount of from 0.01% to 8% by weight, and preferably from 0.2% to 5% by weight, based on the total weight of the adhesive composition.

With particular preference, the component (B2) may be present in an amount of from 0.01% to 8% by weight, and preferably from 0.2% to 5% by weight, based on the total weight of the adhesive composition.

### (C) Peroxide

According to the present invention, the radiation-curable adhesive composition comprises at least one peroxide (C). The peroxide serves as accelerators for curing of the composition by cationic polymerization.

The peroxide described herein refers to compounds having the —O—O— bond, where the —O—O— bond can easily break, generating free radicals.

In some embodiments, the peroxides used in the present invention does not have one acyl group. Suitable examples of peroxides without acryl groups include cumene hydroperoxide, di-tert-butyl peroxide (DTBP) and the like.

In most cases, the peroxide (C) used in the present invention has at least one acyl group. They can be selected from peracids, acyl peroxides without containing ester groups, peroxyesters and peroxy carbonate type compounds.

Peracids described herein are compounds having the general formula R—CH(═O)O—OH, where R is an alkyl or aryl group.

Acyl peroxides without containing ester groups described herein are compounds having the general formula R₁—CH(═O)—O—O—CH(═O)—R₂, wherein R₁ and R₂ represent alkyl and/or aryl groups. Suitable examples include benzoyl peroxide (BPO), dilauryl peroxide, and the like.

The peroxy carbonate type compounds described herein can be esters of monoperoxycarbonic acid and/or esters of diperoxycarbonic acid. The esters of monoperoxycarbonic acid can have general formula R₃—O—CH(═O)—O—O—R₄, wherein R₃ and R₄ are independently selected from straight-chain alkyl groups, branched-chain alkyl groups, cycloalkyl groups and hydroxyalkyl groups. The esters of diperoxycarbonic acid can have general formula R₅—O—CH(═O)—O—O—CH(═O)—O—R₆, wherein R₅. R₆ are independently selected from straight-chain alkyl groups, branched-chain alkyl groups, cycloalkyl groups and hydroxyalkyl groups. Suitable examples include di(4-tert-butylcyclohexyl)-peroxydicarbonate and the like.

Preferably, peroxyesters are used in the present invention. Peroxyesters described herein are compounds having the general formula R₇—CH(═O)—O—O—R₈, wherein R₇ and R₈ are independently selected from straight-chain alkyl groups, branched-chain alkyl groups, cycloalkyl groups and hydroxyalkyl groups. Notably, peroxyesters containing aryl groups are not suitable to use in the present invention. Suitable examples of peroxyesters include tertiary-butyl peroxy-2-ethylhexanoate, 1,1,3,3-Tetramethylbutyl peroxy-2-ethylhexanoate and the like.

In particularly preferred embodiments, peroxyesters having at least two functional groups are used in the present invention. Such compound has general formula R₉—CH(═O)—O—O—R₁₀—O—O—CH(═O)—R₁₁, wherein R₉, R₁₀, R₁₁ are independently selected from straight-chain alkyl groups, branched-chain, cycloalkyl groups and hydroxyalkyl groups, preferably C1 to C15 straight-chain alkyl groups and branched-chain alkyl groups. Suitable examples include 2,5-dimethyl-2,5-di-(2-ethylhexanoyl-peroxy)hexane and the like.

According to the present invention, the mass ratio between peroxide (C) to ferrocenium salts (B1) is from 0.5 to 8, preferably from 0.5 to 6, more preferably from 1 to 6, in particularly preferably from 1 to 5. The proportion of peroxides is selected in such a way that boosts ferrocenium salt to absorb light and produces free radicals according to the present invention. If the mass ratio of peroxide (C) to ferrocenium salts (B1) is lower than 0.5, with irradiation penetrating a polymer film, the present adhesive composition is unable to be fully cured.

Suitable commercially available peroxides (C) are sold under Trigonox 141, Trigonox 121, Trigonox 26 and Perkadox 16 from AkzoNobel, Luperox 26 from Akema, Cumene hydroperoxide and Dicumyl peroxide from Sigma-Aldrich.

With particular preference, the component (C) may be present in an amount of from 0.01% to 7% by weight, and preferably from 1% to 5% by weight, based on the total weight of the adhesive composition.

### (D) Free Radically Polymerizable Compound

According to the present invention, the radiation-curable adhesive composition optionally comprises at least one free radically polymerizable compound (D).

The free-radical polymerizable component (D), that is, a component which undergoes polymerization initiated by free radicals. Useful free-radical polymerizable components are acrylates and methacrylates monomers, oligomers, and/or polymers; they are monofunctional or polyfunctional materials, i.e., have 1, 2, 3, 4, 5, 6, 7, 8, 9, 10 . . . 20 . . . 30 . . . 40 . . . 50 . . . 100, or more functional groups that can polymerize by free radical initiation, may contain aliphatic, aromatic, cycloaliphatic, arylaliphatic, heterocyclic moiety(ies), or any combination thereof. Examples of polyfunctional materials include dendritic polymers such as dendrimers, linear dendritic polymers, dendrigraft polymers, hyperbranched polymers, star branched polymers, and hypergraft polymers.

Examples of free-radical polymerizable components include acrylates and methacrylates such as isobornyl(meth)acrylate, bornyl (meth)acrylate, tricyclodecanyl (meth)acrylate, dicyclopentanyl (meth)acrylate, dicyclopentenyl(meth)acrylate, cyclohexyl (meth)acrylate, benzyl (meth)acrylate, 4-butylcyclohexyl (meth)acrylate, acryloyl morpholine, (meth)acrylic acid, 2-hydroxyethyl (meth)acrylate, 2-hydroxypropyl (meth)acrylate, 2-hydroxybutyl (meth)acrylate, methyl (meth)acrylate, ethyl (meth)acrylate, propyl (meth)acrylate, isopropyl (meth)acrylate, butyl (meth)acrylate, amyl (meth)acrylate, isobutyl (meth)acrylate, t-butyl (meth)acrylate, pentyl (meth)acrylate, caprolactone acrylate, isoamyl (meth)acrylate, hexyl (meth)acrylate, heptyl (meth)acrylate, octyl (meth)acrylate, isooctyl (meth)acrylate, 2-ethylhexyl (meth)acrylate, nonyl (meth)acrylate, decyl (meth)acrylate, isodecyl (meth)acrylate, tridecyl (meth)acrylate, undecyl (meth)acrylate, lauryl (meth)acrylate, stearyl (meth)acrylate, isostearyl (meth)acrylate, tetrahydrofurfuryl (meth)acrylate, butoxyethyl (meth)acrylate, ethoxydiethylene glycol (meth)acrylate, benzyl (meth)acrylate, phenoxyethyl (meth)acrylate, polyethylene glycol mono(meth)acrylate, polypropylene glycol mono(meth)acrylate, methoxyethylene glycol (meth)acrylate, ethoxyethyl (meth)acrylate, methoxypolyethylene glycol (meth)acrylate, methoxypolypropylene glycol (meth)acrylate, diacetone (meth)acrylamide, beta-carboxyethyl (meth)acrylate, phthalic acid (meth)acrylate, dimethylaminoethyl (meth)acrylate, diethylaminoethyl (meth)acrylate, butylcarbamylethyl (meth)acrylate, n-isopropyl (meth)acrylamide fluorinated (meth)acrylate, 7-amino-3,7-dimethyloctyl (meth)acrylate.

Examples of polyfunctional free-radical polymerizable components include those with (meth)acryloyl groups such as trimethylolpropane tri(meth)acrylate, pentaerythritol (meth)acrylate, ethylene glycol di(meth)acrylate, bisphenol A diglycidyl ether di(meth)acrylate, dicyclopentadiene dimethanol di(meth)acrylate, [2-[1,1-dimethyl-2-[(1-oxoallyl)oxy]ethyl]-5-ethyl-1,3-dioxan-5-yl]methyl acrylate; dipentaerythritol monohydroxypenta(meth)acrylate, propoxylated trimethylolpropane tri(meth)acrylate, propoxylated neopentyl glycol di(meth)acrylate, tetraethylene glycol di(meth)acrylate, polyethylene glycol di(meth)acrylate, 1,4-butanediol di(meth)acrylate, 1,6-hexanediol di(meth)acrylate, neopentyl glycol di(meth)acrylate, polybutanediol di(meth)acrylate, tripropyleneglycol di(meth)acrylate, glycerol tri(meth)acrylate, phosphoric acid mono- and di(meth)acrylates, C7-C20 alkyl di(meth)acrylates, tris(2-hydroxyethyl) isocyanurate tri(meth)acrylate, tris(2-hydroxyethyl) isocyanurate di(meth)acrylate, pentaerythritol tri(meth)acrylate, pentaerythritol tetra(meth)acrylate, dipentaerythritol hexa(meth)crylate, tricyclodecane diyl dimethyl di(meth)acrylate and alkoxylated versions (e.g., ethoxylated and/or propoxylated) of any of the preceding monomers, and also di(meth)acrylate of a diol which is an ethylene oxide or propylene oxide adduct to bisphenol A, di(meth)acrylate of a diol which is an ethylene oxide or propylene oxide adduct to hydrogenated bisphenol A, epoxy (meth)acrylate which is a (meth)acrylate adduct to bisphenol A of diglycidyl ether, diacrylate of polyoxyalkylated bisphenol A, and triethylene glycol divinyl ether, and adducts of hydroxyethyl acrylate.

In accordance with an embodiment, the radically polymerizable component is a polyfunctional (meth)acrylate. The polyfunctional (meth)acrylates may include all methacryloyl groups, all acryloyl groups, or any combination of methacryloyl and acryloyl groups. In an embodiment, the free-radical polymerizable component is selected from the group consisting of bisphenol A diglycidyl ether di(meth)acrylate, ethoxylated or propoxylated bisphenol A or bisphenol F di(meth)acrylate, dicyclopentadiene dimethanol di(meth)acrylate, [2-[1,1-dimethyl-2-[(1-oxoallyl)oxy]ethyl]-5-ethyl-1,3-dioxan-5-yl]methyl acrylate, dipentaerythritol monohydroxypenta(meth)acrylate, dipentaerythritol penta(meth)acrylate, dipentaerythritol hexa(meth)crylate, propoxylated trimethylolpropane tri(meth)acrylate, and propoxylated neopentyl glycol di(meth)acrylate, and any combination thereof.

The above-mentioned radically polymerizable compounds can be used singly or in combination of two or more thereof.

Examples of a commercially available product of the component (D) may include polyester acrylate (product name: EBECRYL81O) manufactured by Daicel-Allnex Ltd., polyester acrylate (product name: M7100) manufactured by Toagosei Co., Ltd, tricyclodecane dimethanol diacrylate (product name: SR 833S) manufactured by Sartomer, and diacrylate ester of bisphenol A epoxy resin (product name: Ebecryl 3700) manufactured by Allnex.

With particular preference, the component (D) may be present in an amount of from 0% to 60% by weight, and preferably from 1% to 50% by weight, based on the total weight of the adhesive composition.

### (E) Polyol

The radiation-curable adhesive composition can optionally comprise at least one polyol (E). Polyols are effective in increasing the adhesiveness of the resin system of the present invention. The suitable polyol can be selected from polyester polyols and/or polyether polyols, preferably polyester polyols.

The examples of polyester polyols include condensation-type polyester polyols, addition-polymerization polyester polyols, polycarbonate polyols and the like. Condensation-type polyester polyols may be obtained by condensation reaction of diol compounds, such as ethylene glycol, propylene glycol, diethylene glycol, 1,4-butanediol, neopentyl glycol, 1,6-hexane diol, 3-methyl-1,5-pentanediol, 1,9-nonanediol, 1,4-hexanedimethanol, dimer-acid diol and polyethylene glycol, and organic polybasic acid, such as adipic acid, isophthalic acid, terephthalic acid and sebacic acid, and the molecular weight is preferably 100 to 100,000. Addition-polymerization polyester polyols may include polycaprolactones and the molecular weight thereof is preferably 100 to 100,000. Polycarbonate polyols may be prepared by the direct phosgenation or the ester-exchange method with diphenylcarbonate, each from polyols. The molecular weight thereof is preferably 100 to 100,000.

Suitable examples of polyester polyols include poly(hexanediol adipate) polyol, poly(butanediol adipate) polyol, poly-epsilon-caprolactone polyol, poly(hexanediol dodecanedioate) polyol, poly(hexanediol adipic acid terephthalate) polyol, and mixture thereof.

The examples of polyether polyols include PEG-type, PPG-type, PTO-type and the like, PEG-type polyols are obtainable by the addition polymerization of ethylene oxide using a compound having active hydrogen as a reaction initiation material; and the molecular weight thereof is preferably 100 to 100,000. PPG-type polyols are obtainable by the addition polymerization of propylene oxide using a compound having active hydrogen as a reaction initiation material; and the molecular weight thereof is preferably 100 to 100,000. PTG-type polyols are obtainable by the cationic polymerization of tetrahydrofuran; and the molecular weight thereof is preferably 100 to 100,000.

Suitable examples of polyether polyols can be polypropanediol, polytetramethylene ether glycol, poly(oxypropylene) glycol, polyethylene oxide, polybutylene oxide, and ethylene oxide endcapped versions of any of the foregoing. The most preferred polyether polyols are polytetramethylene ether glycol, poly(oxypropylene) glycol, and ethylene oxide endcapped poly(oxypropylene)glycol.

Examples of commercially available polyols used in the present invention are under trade names ETERNACOLL UM-90 (1/1), Etemacoll UHCSO Capa 3050, Capa 2200, Capa 3091 by Perstorp, Liquiflex H by Petroflex, Merginol 901 by HOBUM Oleochemicals, Placcel 305, Placcel CD 205 PL by Deicel Corporation, Priplast 3172, Priplast 3196 by Croda, Kuraray Polyol F-3010, Kuraray Polyol P-6010 by Kuraray Co., Ltd., Krasol LBH-2000, Krasol HLBH-P3000 by Cray Valley or Hoopol S-1015-35 or Hoopol S-1063-35 by Synthesia Internacional SLU.

With particular preference, the component (E) may be present in an amount of from 0% to 80% by weight, and preferably from 1% to 60% by weight, based on the total weight of the adhesive composition.

### (F) Additive

The composition of this invention may further comprise a silane coupling agent, a filler, a thixotropic agent, a pigment, a surfactant, a preservative, a plasticizer, a lubricant, a defoamer and combinations thereof.

Examples of a silane coupling agent include, but not limited to, 3-aminopropyltriethoxysilane, 3-mercaptopropyltrimethoxysilane, 3-glycidoxypropyltrimethoxysilane. Suitable commercial products are SH6062 and SZ6030 available from Toray-Dow Corning Silicone Inc., KB E903 and KBM803 available from Shin-Etsu Silicone Inc, and Sliquest A-187 available from Momentive. Silane coupling agent may be present in an amount of from 0% to 15% by weight, and preferably from 1% to 10% by weight, based on the total weight of the adhesive composition.

Examples of a filler include, but not limited to, silica, alumina, aluminum nitride, fumed silica, precipitated silica, fumed titanium oxide and combinations thereof. Suitable commercially available products are sold under PLV6 available from Tatsumori. Filler may be present in an amount of from 0% to 95% by weight, and preferably from 1% to 90% by weight, based on the total weight of the adhesive composition.

Thixotropic agents can be used to modify the viscosity of the adhesive composition. The suitable thixotropic agent is fumed silica. Commercial product of fumed silica is available under TS720 available from Cabot. Thixotropic agent may be present in an amount of from 0% to 10% by weight, and preferably from 1% to 5% by weight, based on the total weight of the adhesive composition.

Notably, the composition of this invention is preferred to not comprise any sensitizer selected from anthracene, perylene, phenothiazine, xanthone, thioxanthone, benzophenone, ethyl-4 dimethylaminobenzoate or sterically hindered amines.

### Adhesive Composition

In particular preferred embodiments, the radiation-curable adhesive composition, based on the total weight of the adhesive composition, comprises:
from 2% to 99% by weight, and preferably from 5% to 95% by weight of at least one cationically polymerizable component,
from 0.01% to 8% by weight, and preferably from 0.2% to 5% by weight of at least one ferrocenium salt,
from 0.01% to 8% by weight, and preferably from 0.2% to 5% by weight of at least one aromatic iodonium salt,
from 0.01% to 7% by weight, and preferably from 1% to 5% by weight of at least one peroxide,
from 0% to 60% by weight, and preferably from 1% to 50% by weight of at least one free radically polymerizable compound,
from 0% to 80% by weight, and preferably from 1% to 60% by weight of at least one polyol,
from 0% to 15% by weight, and preferably from 1% to 10% by weight pf at least one silane coupling agent,
from 0% to 95% by weight, and preferably from 1% to 90% by weight of at least one filler, and
from 0% to 10% by weight, and preferably from 1% to 5% by weight of at least one thixotropic agent.

### Preparation Method and Curing Profile

The radiation-curable adhesive composition according to the present invention can be prepared by mixing all the components according to the present invention avoid using visible light until a homogeneous composition is formed.

The apparatuses for these mixing, stirring, dispersing, and the like are not particularly limited. There can be used an automated mortar, a Henschel mixer, a three-roll mill, a ball mill, a planetary mixer, a bead mill, and the like which are equipped with a stirrer and a heater. Also, an appropriate combination of these apparatuses may be used. The preparation method of the radiation-curable adhesive composition is not particularly limited, as long as a composition in which the above-described components are uniformly mixed.

According to the present invention, the radiation-curable adhesive composition is capable of being cured by visible light penetrating a polymer film, in which the visible light has a wavelength of no less than 400 nm, preferably from 400 nm to 500 nm.

In preferred embodiments, the radiation-curable adhesive composition is capable of being cured in one-step by visible light penetrating a polymer film, in which the visible light has a wavelength of no less than 400 nm, preferably from 400 nm to 500 nm.

In preferred embodiments, the said polymer film can be selected from polyimide film, polycarbonate film, polybutylene terephthalate film and polyamide film, more preferably polyimide film. The said polymer film does not have to be contact the adhesive composition.

In preferred embodiments, the radiation time can be as short as 1 second to as long to 20 minutes, preferable from 1 second to 10 minutes.

Preferably, the light radiation source is an LED light radiation lamp. A commercial product of LED light radiation lamp is available under UPP10SIF-031 from UVATA with an emission maximum at 450 nm and an intensity of 300 to 500 mW/cm².

According to the present invention, the cured product of the radiation-curable adhesive composition can achieve an adhesion strength of more than 10 Kgf based on dot shear test described herein.

As will be understood, the time and temperature curing profile for each radiation-curable adhesive composition will vary, and different compositions can be designed to provide the curing profile that will be suited to the particularly industrial manufacturing process.

### Connection Structure and Electronic Device

According to a second aspect of the invention, provided herein is a connection structure, comprising a first part, a second part, and an adhesive sandwiched therebetween, wherein the first and second parts are independently of each other selected from a glass, a polymer film and a metal, preferably at least one parts is a polymer film, and the adhesive being formed by curing the radiation-curable adhesive composition according to the present invention.

In preferred embodiments, at least one of the parts can be selected from resins such as polyimide film, polycarbonate film, polybutylene terephthalate film and polyamide film, more preferably polyimide film.

The first part and/or second part can be of a single material and a single layer or can include multiple layers of the same or different material. The layers can be continuous or discontinuous.

The first part and/or second part can be different shape and different size, even with complex structure, in such circumstances, the adhesive sandwiched therebetween may contact only a portion of the first part and/or second part.

In particular an embodiment, the radiation-curable adhesive composition according to the present invention is injected into the first part covered by a mould, then a second part is placed onto the mould, after curing the composition, the mould is taken away.

The parts of the article descried herein can have a variety of properties including rigidity (e.g., rigid parts i.e., the part cannot be bent by an individual using two hands or will break if an attempt is made to bend the part with two hands), flexibility (e.g., flexible parts i.e., the part can be bent using no greater than the force of two hands), porosity, conductivity, lack of conductivity, and combinations thereof, preferably flexible parts.

The parts of the article can be in a variety of forms including, e.g., fibers, threads, yarns, wovens, nonwovens, films (e.g., polymer film, metallized polymer film, continuous films, discontinuous films, and combinations thereof), foils (e.g., metal foil), sheets (e.g., metal sheet, polymer sheet, continuous sheets, discontinuous sheets, and combinations thereof), and combinations thereof, preferably film.

The method of preparing a connection structure according to the present invention comprising the following steps:
(a) providing a radiation-curable composition according to the present invention,
(b) applying the composition onto a first part,
(c) applying a second part to the composition on the first part thus forming a connection structure,
(d) irradiating the connection structure with visible light having a wavelength of no less than 400 nm, preferably from 400 nm to 500 nm, and
(e) optionally heating the composition on the connection structure.

In step (b), the radiation-curable adhesive composition of the present invention can be applied to a part using any suitable application method including, e.g., automatic fine line dispensing, jet dispensing, slot die coating, roll coating, gravure coating, transfer coating, pattern coating, screen printing, spray coating, filament coating, by extrusion, air knife, trailing blade, brushing, dipping, doctor blade, offset gravure coating, rotogravure coating, joining, casting, molding, sealing and combinations thereof, preferably molding.

The radiation-curable adhesive composition can be applied as a continuous or discontinuous coating, in a single or multiple layers and combinations thereof.

The radiation time in step (d) can be as short as 1 second to as long to 20 minutes, preferable from 1 second to 10 minutes.

Preferably, the light radiation source is an LED light radiation lamp. A commercial product of LED light radiation lamp is available under UPP10SIF-031 from UVATA with an emission maximum at 450 nm and an intensity of 300 to 500 mW/cm².

Directly after radiation, a final curing occurs at room temperature within at most 7 days, preferably within 5 days and particularly preferably within 3 days. The curing reaction can be accelerated by heating.

In step (e), heat, for example, can be introduced by means of convection furnaces, thermoses, IR radiators, laser or induction.

At a temperature of 60° C., the radiation-curable adhesive compositions can be completely cured within 4 hours, preferably within 2 hours. At a temperature of 80° C., curing can be typically completed within 2 hours, preferably within 1 hour. Temperature-graded curing profiles are also workable.

According to a fourth aspect of the invention, provided herein is an electronic device, comprising the connection structure of the present invention or produced using the adhesive composition according to the present invention.

### Use

According to a fifth aspect of the invention, provided herein is the use of the radiation-curable adhesive composition according to the present invention or the connection structure according to the present invention in manufacturing electronic devices.

The said suitable electronic devices includes, but not limited to, e.g., wearable electronic devices (e.g., wrist watches and eyeglasses), handheld electronic devices (e.g., phones (e.g., cellular telephones and cellular smartphones), cameras, tablets, electronic readers, monitors (e.g., monitors used in hospitals, and by healthcare workers, athletes and individuals), watches, calculators, mice, touch pads, and joy sticks), computers (e.g., desk top and lap top computers), computer monitors, televisions, media players, or other electronic components, preferably a camera module.

### EXAMPLES

The following examples are intended to assist one skilled in the art to better understand and practice the present invention. The scope of the invention is not limited by the examples but is defined in the appended claims. All parts and percentages are based on weight unless otherwise stated.

### Raw Materials:

(A1) Celloxide 2021P is cycloaliphatic epoxy resin, available from Daicel Corporation.
(B1-1) R-Gen™ 261 is (η⁵-2,4-cyclopentadien-1-yl)[(1,2,3,4,5,6-η)-(1-methylethyl)benzene]-iron(I)-hexafluorophosphate (solid), available from Chitec Technology.
(B1-2) R-Gen™ 262 is (η⁵-2,4-cyclopentadien-1-yl)[(1,2,3,4,5,6-η)-(1-methylethyl)benzene]-iron(I)-hexafluoroantimonate (solid), available from Chitec Technology.
(B2) BLUESIL™ PI 2074 is (tolylcumyl) iodonium tetrakis (pentafluorophenyl) borate (solid), available from Bluestar.
(B2′) UVI 6976 is triarylsulfonium hexafluoroantimonate salts in 50% by weight of propylene carbonate, available from Dow.
(C1) Trigonox 141 is 2,5-bis(2-ethylhexanoylperoxy)-2,5-dimethylhex, available from Akzo Nobel.
(D1) SR 833 S is acrylate monomer, available from Sartomer.
(E1) Capa 3050 is polyester polyol, available from Perstorp.
(F1) PLV6 is silica filler, available from Tatsumori.
(F2) Sliquest A-187 is silane promoter, available from Momentive.
(F3) TS720 is fumed silica, available from Cabot.

### Test Methods:

State after 60s Light Radiation with Wavelength of 450 nm Beneath PI Film

The composition of each comparative example and inventive example was dispensed onto a polycarbonate substrate (1225Y) with a diameter around 3 mm, and a polyimide (PI) film with a size of 110*35 mm (Kapton HN PI film, 50 μm thickness, manufactured by Dupont) was horizontally fixed on the top of the adhesion dot at a distance of 5 mm.

A LED light radiation with wavelength of 450 nm at the intensity of 18 J/cm² (300 mw) (UPP10SIF-031 available from UVATA) was performed on the top of the PI film for a period of 60 seconds to cure the aforementioned specimen. And then the specimens took place at room temperature for 24 hours.

To assess the composition's state, the compositions are subjected to an optical assessment. The state was recorded in Table 1. A solid state indicates the composition was fully cured beneath PI film, which can be acceptable. While a liquid state or composition having only surface solidified cannot be acceptable.

### Adhesion Strength

The composition of each comparative example and inventive example was dispensed onto a polycarbonate substrate (1225Y) with a diameter around 3 mm, and a polyimide (PI) film with a size of 110*35 mm (Kapton HN PI film, 50 um thickness, manufactured by Dupont) was horizontally fixed on the top of the adhesion dot in a distance of 5 mm.

A LED light radiation with wavelength of 450 nm at the intensity of 18 J/cm² (300 mw) (UPP10SIF-031 available from UVATA) was performed on the top of the PI film for a period of 60 seconds to cure the aforementioned specimen. And then the specimens took place at room temperature for 24 hours.

To determine the adhesion strength at break of an adhesive dot, the dot shear strength of the samples was measured by DAGE 4000 shear tester with a test speed of 300 um/s. The shear force was tested and recorded as Kgf in Table 1. The adhesive composition was considered to be acceptable where the shear force was greater than 10 Kgf, preferably greater than 12 Kgf.

### Inventive Examples 1 to 9 (Ex.1 to Ex.9) and Comparative Examples 1 to 5 (CEx.1 to CEx. 5)

The composition of each comparative example and inventive example was prepared by the following steps:
Firstly, the ferrocenium salt (B1) if present, was weighed in weight mass specified in Table 1 and dissolved in 50% by weight of propylene carbonate based on total weight of ferrocenium salt solution prior to use;
Secondly, the aromatic iodonium salt (B2) present, was weighed in weight mass specified in Table 1 and dissolved in 50% by weight of propylene carbonate based on total weight of aromatic iodonium salt solution prior to use;
Thirdly, mixing the above two solutions together until a homogeneity was obtained; and
Lastly, mixing the rest of the components in weight mass specified in Table 1 with the mixture obtained in the third step in a Speedmixer DAC400 until a homogeneous composition formed.

The above steps were performed under yellow radiation with the wavelength of 595 nm. The properties were tested using the methods stated above, and the results of evaluations are shown in Table 1.

TABLE 1

| | Components (parts by weight) | | | | | | | | | | | | | |
|---|---|---|---|---|---|---|---|---|---|---|---|---|---|---|
| | CEx. 1 | CEx. 2 | CEx. 3 | CEx. 4 | CEx. 5 | Ex. 1 | Ex. 2 | Ex. 3 | Ex. 4 | Ex. 5 | Ex. 6 | Ex. 7 | Ex. 8 | Ex. 9 |
| (A1) | 50 | 50 | 50 | 50 | 50 | 50 | 50 | 50 | 50 | 50 | 50 | 50 | 38.3 | 43.7 |
| Celloxide | | | | | | | | | | | | | | |
| 2021P | | | | | | | | | | | | | | |
| (B1-1) R- | 0 | 0 | 0 | 0 | 0.3 | 0 | 0 | 0 | 0.3 | 0.3 | 0.3 | 0.3 | 0 | 0 |
| Gen ™ | | | | | | | | | | | | | | |
| 262 | | | | | | | | | | | | | | |
| (B1-2) R- | 2 | 2 | 2 | 2 | 0 | 2 | 2 | 2 | 0 | 0 | 0 | 0 | 1.5 | 1.7 |
| Gen ™ | | | | | | | | | | | | | | |
| 261 | | | | | | | | | | | | | | |
| (B2) | 2 | 0 | 0 | 4 | 0.15 | 0.5 | 1 | 2 | 0.15 | 0.15 | 0.15 | 0.15 | 1.5 | 1.7 |
| BLUESIL ™ | | | | | | | | | | | | | | |
| PI | | | | | | | | | | | | | | |
| 2074 | | | | | | | | | | | | | | |
| (B2′) UVI | 0 | 0 | 4 | 0 | 0 | 0 | 0 | 0 | 0 | 0 | 0 | 0 | 0 | 0 |
| 6976 | | | | | | | | | | | | | | |
| (C) | 0 | 2 | 2 | 2 | 0.09 | 2 | 2 | 2 | 0.15 | 0.3 | 1.8 | 2.4 | 1.5 | 1.7 |
| Trigonox | | | | | | | | | | | | | | |
| 141 | | | | | | | | | | | | | | |
| (D) SR | 0 | 0 | 0 | 0 | 0 | 0 | 0 | 0 | 0 | 0 | 0 | 0 | 20 | 10 |
| 833 S | | | | | | | | | | | | | | |
| (E) Capa | 30 | 30 | 30 | 30 | 30 | 30 | 30 | 30 | 30 | 30 | 30 | 30 | 23 | 26.2 |
| 3050 | | | | | | | | | | | | | | |
| (F1) | 10 | 10 | 10 | 10 | 10 | 10 | 10 | 10 | 10 | 10 | 10 | 10 | 7.7 | 8.9 |
| PLV6 | | | | | | | | | | | | | | |
| (F2) | 1 | 1 | 1 | 1 | 1 | 1 | 1 | 1 | 1 | 1 | 1 | 1 | 0.8 | 0.9 |
| Sliquest | | | | | | | | | | | | | | |
| A-187 | | | | | | | | | | | | | | |
| (F3) | 2 | 2 | 2 | 2 | 2 | 2 | 2 | 2 | 2 | 2 | 2 | 2 | 2.7 | 1.8 |
| TS720 | | | | | | | | | | | | | | |
| (B2):(B1) | 1 | 0 | 0 | 4 | 0.5 | 0.25 | 0.5 | 1 | 0.5 | 0.5 | 0.5 | 0.5 | 1 | 1 |
| (C):(B1) | 0 | 1 | 1 | 1 | 0.3 | 1 | 1 | 1 | 0.5 | 1 | 6 | 8 | 1 | 1 |
| Testing | | | | | | | | | | | | | | |
| results | | | | | | | | | | | | | | |
| State after 60 s | Liquid | Solid | Solid | Solid | Only | Solid | Solid | Solid | Solid | Solid | Solid | Solid | Solid | Solid |
| radiation with | | | | | surface | | | | | | | | | |
| wavelength of | | | | | solid | | | | | | | | | |
| 450 nm beneath | | | | | | | | | | | | | | |
| PI film (Solid/ | | | | | | | | | | | | | | |
| liquid) | | | | | | | | | | | | | | |
| Adhesion | N/A | 7.61 | 8.77 | 5.32 | N/A | 16.69 | 18.44 | 17.03 | 14.53 | 16.13 | 13.96 | 13.86 | 18.19 | 21.32 |
| strength | | | | | | | | | | | | | | |
| (Kgf) | | | | | | | | | | | | | | |

N/A refers to that the composition is not completely cured therefore adhesive strength cannot be tested.

As can be seen from Table 1, the comparative example 1 without having peroxide cannot be cured with radiation penetrating a PI film. Although both the comparative example 2 without having aromatic iodonium salt (B2) and comparative example 3 having aryl sulfonium salt replacing with aromatic iodonium salt were cured after light radiation with wavelength of 450 nm, the adhesive strength of both compositions when cured were not satisfactory. The comparative examples 4 to 5 having the mass ratio between component (B2) to component (B1) or component (C) to component (B1) beyond the claimed range exhibited unsatisfactory adhesion strength when cured. In contrast, the radiation-curable adhesive composition of the present invention exhibited excellent adhesion strength when cured.

Although some preferred embodiments have been described, many modifications and variations may be made thereto in light of the above teachings. It is therefore to be understood that the invention may be practiced otherwise than as specifically described without departing from the scope of the appended claims.

What is claimed is:

1. A radiation-curable adhesive composition comprising
(A) at least one cationically polymerizable component,
(B) at least one photoinitiator system comprising
(B1) at least one ferrocenium salt, and
(B2) at least one aromatic iodonium salt,
(C) at least one peroxide, and
(D) optionally at least one free radically polymerizable compound;
wherein the mass ratio between the component (B2) to the component (B1) is from 0.25 to less than 4; and the mass ratio between the component (C) to the component (B1) is from 0.5 to 8.

2. The radiation-curable adhesive composition according to claim 1, wherein the component (A) is selected from cyclic ether compound, cyclic lactone compound, cyclic acetal compound, cyclic thioether compound, spiro-orthoester compound, oxetane compound and cycloaliphatic epoxy resin, and combinations thereof.

3. The radiation-curable adhesive composition according to claim 1, wherein the component (B1) is selected from cumenylcyclopentadienyl iron (II) hexafluorophosphate, cumenylcyclopentadienyl iron (II) hexafluoroantimonate, naphthalenylcyclopentadienyl iron (II) hexafluorophosphate, benzylcyclopentadienyl iron (II) hexafluorophosphate and cyclopentadienyl carbazole iron (II) hexafluorophosphate, and combinations thereof.

4. The radiation-curable adhesive composition according to claim 1, wherein component (B2) is selected from [4-(isooctyloxy)phenyl]2-pyrazoyliodonium hexafluoroantimonate; [4-(2-ethylhexyloxy)phenyl]phenyliodonium hexafluoroantimonate; [4-(2-methylpentoxy)phenyl]phenyliodonium tetrafluoroborate; [4-(3-methylpentoxy)phenyl]phenyliodonium hexafluorophosphate; [4-(4-methylpentoxy)phenyl]phenyliodonium hexafluoroantimonate; [4-(2-propylpentoxy)phenyl]phenyliodonium hexafluoroantimonate; [4-(2,4,4-trimethylpentoxy)phenyl]phenyliodonium hexafluorophosphate; [4-(2-ethylheptyloxy)phenyl]phenyliodonium hexafluoroarsenate; [4-(3,7-dimethyloctyloxy)phenyl]phenyliodonium hexafluoroantimonate; [4-(2-ethylhexyloxy)phenyl]-2-thienyliodonium hexafluorophosphate, [4-(2-ethylhexyloxy)phenyl]2-furanyl-iodonium hexafluoroantimonate, tolylcumyliodonium-tetrakis pentafluorophenylborate, and combinations thereof.

5. The radiation-curable adhesive composition according to claim 1, wherein the component wherein the mass ratio between component (B2) to component (B1) is from 0.25 to 3.

6. The radiation-curable adhesive composition according to claim 1, wherein the component (C) is peroxide without acyl groups and/or peroxides having at least one acyl group selected from peracids, acyl peroxides without containing ester groups, peroxyesters and peroxy carbonate type compounds.

7. The radiation-curable adhesive composition according to claim 1, wherein the component (C) to component (B1) is from 0.5 to 6.

8. The radiation-curable adhesive composition according to claim 1, wherein the component (D) is selected from acrylates and methacrylates monomers, oligomers, and/or polymers.

9. The radiation-curable adhesive composition according to claim 1, wherein the composition further comprise a polyol component (E) is selected from polyester polyols and/or polyether polyols.

10. The radiation-curable adhesive composition according to claim 1, wherein the composition further comprise an additive (F) selected from silane coupling agent, filler, thixotropic agent, pigment, surfactant, preservative, plasticizer, lubricant, defoamer and combinations thereof.

11. The radiation-curable adhesive composition according to claim 1, wherein the composition is capable of being cured by visible light penetrating a polymer film, in which the visible light has a wavelength of no less than 400 nm.

12. A connection structure, comprising a first part, a second part, and an adhesive sandwiched therebetween, wherein the first and second parts are independently of each other selected from a glass, a polymer film and a metal.

13. A method for preparing the connection structure according to claim 12, comprising the following steps:
(a) providing a radiation-curable composition,
(b) applying the composition onto a first part,
(c) applying a second part to the composition on the first part thus forming a connection structure,
(d) irradiating the connection structure with visible light having a wavelength of no less than 400 nm, and
(e) optionally heating the composition on the connection structure.

14. An electronic device, comprising the connection structure of claim 12.
